(19) United States
(12) Patent Application Publication
(10) Pub. No.: US 2019/0043132 A1
(43) Pub. Date: Feb. 7, 2019

(54) FUNDED PENSION PROCESSING DEVICE, METHOD, AND COMPUTER PROGRAM

(71) Applicant: Doreming LLC, Tokyo (JP)

(72) Inventor: Yoshikazu TAKASAKI, Tokyo (JP)

(73) Assignee: Doreming LLC, Tokyo (JP)

(21) Appl. No.: 16/075,508

(22) PCT Filed: Feb. 1, 2017
(86) PCT No.: PCT/JP2017/003549

§ 371 Date: Aug. 3, 2018

(30) Foreign Application Priority Data
Feb. 5, 2016 (JP) 2016-020554

(51) Int. Cl. G06Q 40/06; G06Q 20/10; G06Q 50/26

(52) U.S. Cl. CPC G06Q 40/06; G06Q 50/26; G06Q 20/102

(57) ABSTRACT

[Problem] To provide a technique whereby a pension is accumulated through a commodity purchase and other consumption, and it is thereby possible to accumulate a pension while avoiding consumption stagnation.

[Solution] A funded pension processing device (1) for providing, in response to a commodity purchase by a user, a funded pension service for accumulating a portion of the charge for the commodity as a funded pension for the user has a funded pension information DB (1C) for storing information pertaining to the funded pension accumulated in accordance with purchasing of the commodity by the user. When user identification information, information pertaining to a settlement amount accompanying the commodity purchase, and information pertaining to a funded pension sum that is set for the commodity are received from a store terminal (3) as settlement information of the commodity purchase by the user, a request for payment processing of the settlement amount to the store and a request for accumulation processing of the funded pension that is set for the commodity are transmitted together with the settlement information to a financial institution terminal (4). When notification that accumulation processing of the funded pension is completed is received from the financial institution terminal (4), information pertaining to the funded pension for which accumulation processing is completed is registered in a funded pension information DB (1C).

### TECHNICAL FIELD

The present invention relates to a technique whereby, in response to purchasing of a commodity, a portion of the charge for the purchased commodity is accumulated as a funded pension for the commodity purchaser.

### BACKGROUND ART

Public pensions hold an important place as sources of income in old age.

Public pension plans include a funded scheme in which money paid in is accumulated and the money is then received in old age, and a pay-as-you-go scheme in which money paid in by actively working people is supplied to the current elderly, and intergenerational support is currently realized in Japan by a pay-as-you-go scheme.

However, many developed countries are coming to the end of a period of high economic growth, and are facing fiscal deficits due to birthrate decline and other effects, and because participation is required from all citizens in some countries but not in other countries, public pension plans in a pay-as-you-go scheme are becoming extremely difficult to maintain.

Meanwhile, few elderly are living solely on old-age savings or funded personal pensions, and there is a need for maintenance and stable operation of public pension plans.

Such problems are as understood also from the proposal in Patent Document 1, for example, of a system for forecasting public pension financing and stochastically analyzing risk in view of a condition in which increased burden on the working generation is unavoidable due to the decreasing birthrate and aging of the population.

### PRIOR ART DOCUMENTS

### Patent Documents

[Patent Document 1] Japanese Laid-open Patent Application No. 2008-257310

### DISCLOSURE OF THE INVENTION

### Problems the Invention is Intended to Solve

A method for gradually converting from a pay-as-you-go scheme to a funded scheme may therefore be necessary, but it is difficult to make an abrupt conversion from the pay-as-you-go scheme to a funded scheme. Even if a conversion to a pay-as-you-go scheme were to be made, there is also a fear that consumption will stagnate and that economic growth will be furthermore blunted if there is an increase in the number of people saving for life in old age.

In a method that uses a tax collected as a consumption tax as a pension, shoppers pay the tax at a consumption tax rate uniformly determined by the state.

In view of these problems, the present inventors concluded that it would be preferable to use a method whereby a rate or money sum determined on a store side is accumulated as a pension in accordance with a commodity or an amount of shopping.

Therefore, an object of the present invention is to provide a technique whereby a pension is accumulated through a commodity purchase or other consumption, and it is thereby possible to accumulate a pension while avoiding consumption stagnation.

### Means for Solving the Aforementioned Problems

To achieve the object, a funded pension processing device according to one aspect of the present invention provides, in response to a commodity purchase by a user, a funded pension service for accumulating a portion of the charge for the commodity as a funded pension for the user,

said funded pension processing device characterized by being configured so as to be capable of communicating via a network with a store terminal installed in a store selling the commodity; and

a financial institution terminal for executing processing pertaining to charge amount settlement and pension accumulation accompanying the commodity purchase by the user; and

said funded pension processing device comprising:

funded pension information storage means for storing funded pension information pertaining to the funded pension accumulated in accordance with purchasing of the commodity by the user;

settlement information reception means for receiving, from the store terminal, user identification information for identifying the user, information pertaining to a settlement amount accompanying the commodity purchase by the user, and information pertaining to a funded pension sum that is set for the commodity purchased by the user as settlement information of the commodity purchase by the user;

processing request transmission means for transmitting, together with the settlement information to the financial institution terminal, a request for payment processing of the settlement amount to the store and a request for accumulation processing of the funded pension that is set for the commodity purchased by the user, for the commodity purchase by the user identified by the user identification information;

completion notification reception means for receiving notification from the financial institution terminal that accumulation processing of the funded pension is completed; and

funded pension registration means for registering information pertaining to the funded pension for which the accumulation processing is completed in the funded pension information storage means.

It is also possible to have the funded pension processing device, further comprising:

user information storage means for storing applicability of the funded pension service for each user; and determination processing means for referring to the user information storage means and determining applicability of the funded pension service corresponding to the commodity purchase for the user identified by the user identification information. The processing request transmission means transmitting, together with the settlement information to the financial institution terminal, a request for payment processing of the settlement amount to the store and a request for accumulation processing of the funded pension that is set for the commodity purchased by the user, for the commodity purchase by the user identified by the user identification information when it is determined that the funded pension service corresponding to the commodity purchase can apply for the user identified by the user identification information.

It is also possible to have the funded pension processing device, further configured so as to be able to communicate via a network with a personnel and labor information management device having a personnel and labor information storage means in which personnel and labor information of the user as a worker is stored; and

further comprising applicability registration means for referring to the personnel and labor information storage means and registering, in the user information storage means, the applicability of the funded pension service assigned in accordance with the personnel and labor information.

It is also possible to have the funded pension processing device, further configured so as to be able to communicate via a network with the user terminal used by the user; and

further comprising object commodity information reception means for receiving object commodity information pertaining to an object commodity of the funded pension service from the store terminal; and

object commodity information delivery means for delivering the object commodity information to the user terminal.

It is also possible to have the funded pension processing device, further configured so as to be able to communicate via a network with the user terminal used by the user; and

further comprising inquiry request reception means for receiving an inquiry request for the funded pension information together with the user identification information from the user terminal;

extraction processing means for referring to the funded pension information storage means and extracting the funded pension information on the basis of the user identification information; and

funded pension information delivery means for delivering the funded pension information to the user terminal.

It is also possible to have the funded pension processing device, further comprising conveyance information storage means for storing conveyance information relating to details of conveyance to a third party other than the user, for a portion of the funded pension accumulated in accordance with a commodity purchase by the user;

the processing request transmission means furthermore transmitting the conveyance information stored in the conveyance information storage means.

It is also possible to have the funded pension processing device, further configured so as to be able to communicate via a network with the user terminal used by the user; and

further comprising conveyance information reception means for receiving the conveyance information from the user terminal; and

conveyance information registration means for referring to the conveyance information storage means and registering the conveyance information.

A funded pension processing device according to another aspect of the present invention further provides, in response to a commodity purchase by a user, a funded pension service for accumulating a portion of the price of the commodity as a funded pension for the user,

said funded pension processing device characterized by being configured so as to be capable of communicating via a network with a store terminal installed in a store selling the commodity; and

a financial institution terminal for executing processing pertaining to charge amount settlement and pension accumulation accompanying the commodity purchase by the user; and

said funded pension processing device comprising commodity information storage means for storing setting information pertaining to a funded pension sum that is set for each commodity;

funded pension information storage means for storing funded pension information pertaining to the funded pension accumulated in accordance with purchasing of the commodity by the user;

settlement information reception means for receiving, from the store terminal, user identification information for identifying the user and information pertaining to a settlement amount accompanying the commodity purchase by the user as settlement information of the commodity purchase by the user;

extraction processing means for referring to the commodity information storage means and extracting the setting information pertaining to the funded pension sum that is set for the commodity purchased by the user;

processing request transmission means for transmitting, together with the settlement information and the setting information to the financial institution terminal, a request for payment processing of the settlement amount to the store and a request for accumulation processing of the funded pension that is set for the commodity purchased by the user, for the commodity purchase by the user identified by the user identification information;

completion notification reception means for receiving notification from the financial institution terminal that accumulation processing of the funded pension is completed; and

funded pension registration means for registering information pertaining to the funded pension for which the accumulation processing is completed in the funded pension information storage means.

It is also possible to have the funded pension processing device, further comprising discrimination processing means for referring to the commodity information storage means on the basis of settlement information received from the store terminal and discriminating whether a commodity purchased by the user is an object commodity of the funded pension service;

the commodity information storage means storing setting information pertaining to a funded pension sum that is set for each object item, for the object commodity of the funded pension service; and

the extraction processing means referring to the commodity information storage means when the commodity purchased by the user is discriminated as being an object commodity of the funded pension service, and extracting the setting information pertaining to the funded pension sum that is set for the object commodity purchased by the user.

It is also possible to have the funded pension processing device, further comprising setting information reception means for receiving, from the store terminal, setting information pertaining to the funded pension sum that is set for the commodity; and

setting information registration means for referring to the commodity information storage means and registering the setting information.

A funded pension processing method according to another aspect of the present invention further provides, in response to a commodity purchase by a user, a funded pension service for accumulating a portion of the charge for the commodity as a funded pension for the user,

said funded pension processing method comprising executing processing through use of a computer that is configured so as to be capable of communicating via a network with

a store terminal installed in a store selling the commodity, and

a financial institution terminal for executing processing pertaining to charge amount settlement and pension accumulation accompanying the commodity purchase by the user,

the computer comprising funded pension information storage means for storing funded pension information pertaining to the funded pension accumulated in accordance with purchasing of the commodity by the user, and

the processing comprising:

processing for receiving, from the store terminal, user identification information for identifying the user, information pertaining to a settlement amount accompanying the commodity purchase by the user, and information pertaining to a funded pension sum that is set for the commodity purchased by the user as settlement information of the commodity purchase by the user;

processing for transmitting, together with the settlement information to the financial institution terminal, a request for payment processing of the settlement amount to the store and a request for accumulation processing of the funded pension that is set for the commodity purchased by the user, for the commodity purchase by the user identified by the user identification information;

processing for receiving notification from the financial institution terminal that accumulation processing of the funded pension is completed; and

processing for registering information pertaining to the funded pension for which the accumulation processing is completed in the funded pension information storage means.

A computer program according to another aspect of the present invention further provides, in response to a commodity purchase by a user, a funded pension service for accumulating a portion of the charge for the commodity as a funded pension for the user,

said computer program causing a computer to execute processing, and the computer being configured so as to be capable of communicating via a network with

a store terminal installed in a store selling the commodity, and

a financial institution terminal for executing processing pertaining to charge amount settlement and pension accumulation accompanying the commodity purchase by the user,

the computer comprising funded pension information storage means for storing funded pension information pertaining to the funded pension accumulated in accordance with purchasing of the commodity by the user; and

the processing comprising:

processing for receiving, from the store terminal, user identification information for identifying the user, information pertaining to a settlement amount accompanying the commodity purchase by the user, and information pertaining to a funded pension sum that is set for the commodity purchased by the user as settlement information of the commodity purchase by the user;

processing for transmitting, together with the settlement information to the financial institution terminal, a request for payment processing of the settlement amount to the store and a request for accumulation processing of the funded pension that is set for the commodity purchased by the user, for the commodity purchase by the user identified by the user identification information;

processing for receiving notification from the financial institution terminal that accumulation processing of the funded pension is completed; and

processing for registering information pertaining to the funded pension for which the accumulation processing is completed in the funded pension information storage means.

A funded pension processing method according to another aspect of the present invention further provides, in response to a commodity purchase by a user, a funded pension service for accumulating a portion of the price of the commodity as a funded pension for the user,

said funded pension processing method comprising executing processing through use of a computer that is configured so as to be capable of communicating via a network with

a store terminal installed in a store selling the commodity, and

a financial institution terminal for executing processing pertaining to charge amount settlement and pension accumulation accompanying the commodity purchase by the user,

the computer comprising commodity information storage means for storing setting information pertaining to a funded pension sum that is set for each commodity; and

funded pension information storage means for storing funded pension information pertaining to the funded pension accumulated in accordance with purchasing of the commodity by the user; and

the processing comprising:

processing for receiving, from the store terminal, user identification information for identifying the user and information pertaining to a settlement amount accompanying the commodity purchase by the user as settlement information of the commodity purchase by the user;

processing for referring to the commodity information storage means and extracting the setting information pertaining to the funded pension sum that is set for the commodity purchased by the user;

processing for transmitting, together with the settlement information and the setting information to the financial institution terminal, a request for payment processing of the settlement amount to the store and a request for accumulation processing of the funded pension that is set for the commodity purchased by the user, for the commodity purchase by the user identified by the user identification information;

processing for receiving notification from the financial institution terminal that accumulation processing of the funded pension is completed; and

processing for registering information pertaining to the funded pension for which the accumulation processing is completed in the funded pension information storage means.

A computer program according to another aspect of the present invention further provides, in response to a commodity purchase by a user, a funded pension service for accumulating a portion of the price of the commodity as a funded pension for the user,

said computer program causing a computer to execute processing, and the computer being configured so as to be capable of communicating via a network with

a store terminal installed in a store selling the commodity; and

a financial institution terminal for executing processing pertaining to charge amount settlement and pension accumulation accompanying the commodity purchase by the user,

the computer comprising commodity information storage means for storing setting information pertaining to a funded pension sum that is set for each commodity, and

funded pension information storage means for storing funded pension information pertaining to the funded pension accumulated in accordance with purchasing of the commodity by the user; and

the processing comprising:

processing for receiving, from the store terminal, user identification information for identifying the user and information pertaining to a settlement amount accompanying the commodity purchase by the user as settlement information of the commodity purchase by the user;

processing for referring to the commodity information storage means and extracting the setting information pertaining to the funded pension sum that is set for the commodity purchased by the user;

processing for transmitting, together with the settlement information and the setting information to the financial institution terminal, a request for payment processing of the settlement amount to the store and a request for accumulation processing of the funded pension that is set for the commodity purchased by the user, for the commodity purchase by the user identified by the user identification information;

processing for receiving notification from the financial institution terminal that accumulation processing of the funded pension is completed; and

processing for registering information pertaining to the funded pension for which the accumulation processing is completed in the funded pension information storage means.

### Effect of the Invention

Through the present invention, a pension is accumulated through a commodity purchase or other consumption, and it is thereby possible to accumulate a pension while avoiding consumption stagnation.

### BRIEF DESCRIPTION OF THE DRAWINGS

FIG. 1 is a functional block diagram illustrating the functions provided to the funded pension processing device pertaining to a first embodiment of the present invention;

FIG. 2 is a diagram illustrating an example of the data stored in a user information DB in the funded pension processing device pertaining to the present embodiment;

FIG. 3 is a sequence diagram illustrating the flow of processing executed by the funded pension processing device pertaining to the present embodiment;

FIG. 4 is a diagram illustrating the flow of movement of a settlement amount or the like executed in a financial institution on the basis of a processing request by the funded pension processing device pertaining to the present embodiment;

FIG. 5 is a diagram illustrating the flow of movement of a settlement amount or the like executed in a financial institution on the basis of a processing request by the funded pension processing device pertaining to the present embodiment;

FIG. 6 is a sequence diagram illustrating the flow of processing executed by the funded pension processing device pertaining to the present embodiment;

FIG. 7 is a functional block diagram illustrating the functions provided to the funded pension processing device pertaining to a second embodiment of the present invention;

FIG. 8 is a diagram illustrating an example of the data stored in a commodity information DB in the funded pension processing device pertaining to the present embodiment;

FIG. 9 is a sequence diagram illustrating the flow of processing executed by the funded pension processing device pertaining to the present embodiment;

FIG. 10 is a functional block diagram illustrating the functions provided to the funded pension processing device pertaining to a third embodiment of the present invention;

FIG. 11 is a sequence diagram illustrating the flow of processing executed by the funded pension processing device pertaining to the present embodiment;

FIG. 12 is a sequence diagram illustrating the flow of processing executed by the funded pension processing device pertaining to the present embodiment;

FIG. 13 is a diagram illustrating the flow of movement of a settlement amount or the like executed in a financial institution on the basis of a processing request by the funded pension processing device pertaining to the present embodiment; and

FIG. 14 is a diagram illustrating an example of the data stored in a conveyance information DB in the funded pension processing device pertaining to another aspect of the present invention.

### BEST MODE FOR CARRYING OUT THE INVENTION

The funded pension processing device pertaining to an embodiment of the present invention will be described below with reference to the accompanying drawings.

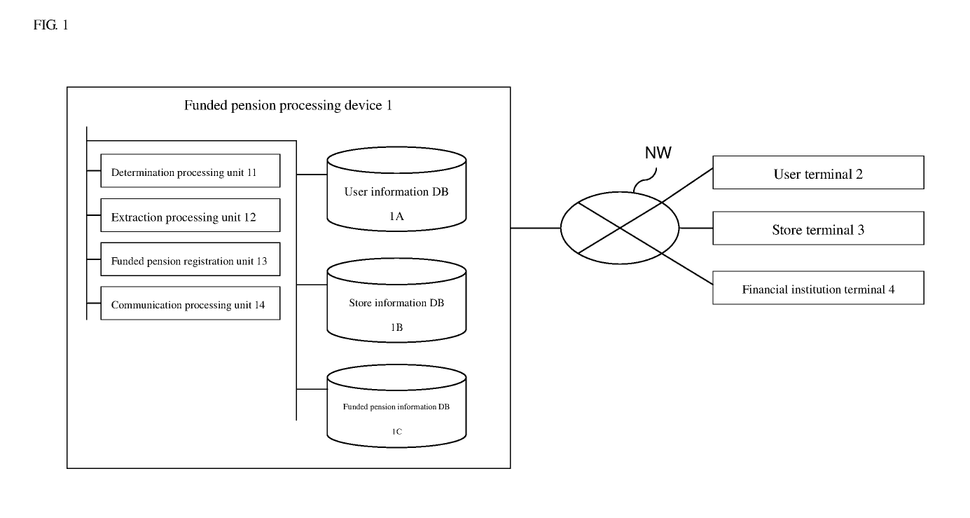

FIG. 1 illustrates the structure of the funded pension processing device 1 pertaining to a first embodiment.

The funded pension processing device 1 is a device for providing, to a person purchasing a predetermined commodity, a funded pension service for accumulating a portion of the charge for the commodity as a funded pension.

This funded pension processing device 1 is configured so as to be able to communicate with a user terminal 2 of a user who uses the funded pension service, a store terminal 3 installed in a store where a commodity is sold, and a financial institution terminal 4 installed in a financial institution for executing processing pertaining to pension accumulation and settlement of charges accompanying commodity purchases by the user, via the Internet or another network NW.

In the term “commodity purchase” in the present example, the commodity is not limited to being a tangible object or an intangible, or to being movable property or real estate, and also includes immaterial service, and includes trade in general that at least generates value.

This funded pension processing device 1 is realized by a so-called server computer or the like, and functional blocks comprising a user information DB 1A, a store information DB 1B, a funded pension information DB 1C, a determination processing unit 11, an extraction processing unit 12, a funded pension registration unit 13, and a communication processing unit 14 are constituted by hardware resources such as a central processing unit (CPU), random access memory (RAM), read-only memory (ROM), and a hard disk drive, and by a computer program or other software resource executed by the CPU.

The user information DB 1A is a storage unit for storing information relating to users registered to use the funded pension service.

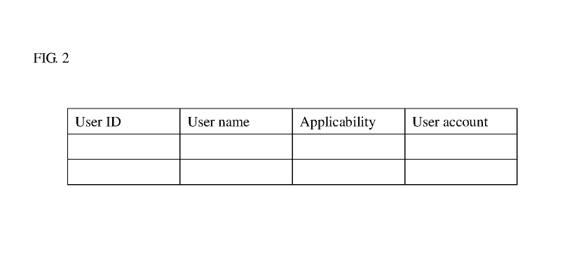

In the user information DB 1A, a user name and information pertaining to applicability of the funded pension service, for example, are stored for each user ID, whereby a user can be identified, as illustrated in FIG. 2. For payment of a charge accompanying a commodity purchase, when money is to be directly withdrawn from an account of the user, information pertaining to the account of the user may additionally be stored.

The applicability of the funded pension service is information indicating whether the registered user is an object or application of the funded pension service. This applicability is set according to whether an arbitrary condition established by an administrator or the like of the service is satisfied. The arbitrary condition may be a condition relating to a personal attribute of the user, such as the age, sex, nationality, a qualification, or other personal information of the user, the yearly income, official position, type of employment, or other employment contract information of the user, as well as to a condition not related to a personal attribute, such as a date, a time period, or a location. A condition may also not be set.

The store information DB 1B is a storage unit for storing information relating to a store that sells a commodity to the user.

In the store information DB 1B, information such as a store name or a payee account for proceeds accompanying sale of a commodity is stored for each store ID, whereby a store can be identified.

The funded pension information DB 1C is a storage unit for storing information of the funded pension accumulated for each user.

In the funded pension information DB 1C, the funded pension is updated and registered by the funded pension registration unit 13 in accordance with a commodity purchase by the user.

When settlement information accompanying a commodity purchase is received together with a user ID from the store terminal 3, the determination processing unit 11 refers to the user information DB 1A and executes processing for determining whether application of the funded pension service is received for the user identified by the user ID.

The extraction processing unit 12 executes processing for extracting information necessary for each processing such as for payment for the commodity or accumulating of the pension from the user information DB 1A, the store information DB 1B, or the funded pension information DB 1C. In response to a funded pension inquiry request from the user, funded pension information correlated with the user ID of the user is extracted from the funded pension information DB 1C.

In response to completion of accumulation processing of the funded pension based on the commodity purchase by the user, the funded pension registration unit 13 refers to the funded pension information DB 1C and registers the funded pension of the user.

The communication processing unit 14 is a functional unit for executing transmission and reception of data to and from the user terminal 2, the store terminal 3, and the financial institution terminal 4 via the Internet or another network NW.

Through use of the communication processing unit 14, the funded pension processing device 1 receives settlement information from the store terminal 3, and transmits payment processing requests or funded pension processing requests to the financial institution terminal 4.

The user terminal 2 is a terminal used by a user who enjoys the funded pension service and obtains the funded pension by purchasing an object commodity of the funded pension service.

The user terminal 2 is realized by a so-called personal computer, tablet terminal, or other terminal capable of transmitting/receiving data or inputting/outputting data via the Internet or another network NW. The user accesses the funded pension processing device 1 via a predetermined website or the like using the user terminal 2, and can transmit an inquiry request for the funded pension of the user, or receive the inquiry result thereof.

The store terminal 3 is a terminal installed in a store that sells a commodity to the user, and is realized as a POS terminal or a computer provided with a POS terminal function.

The store terminal 3 executes processing necessary for payment accompanying a commodity purchase by the user, and presents the funded pension processing device 1 with information necessary for giving the funded pension to the user, the information being set for the commodity.

The financial institution terminal 4 is a terminal installed in a financial institution, for executing processing pertaining to pension accumulation and settlement of charges accompanying commodity purchases by the user, and is realized by a server computer or the like.

In response to a request from the funded pension processing device 1, the financial institution terminal 4 executes transfer processing for commodity charge amounts or the funded pension between store accounts, user accounts, or other accounts, and pension accumulation and settlement of commodity charge amounts are thereby executed.

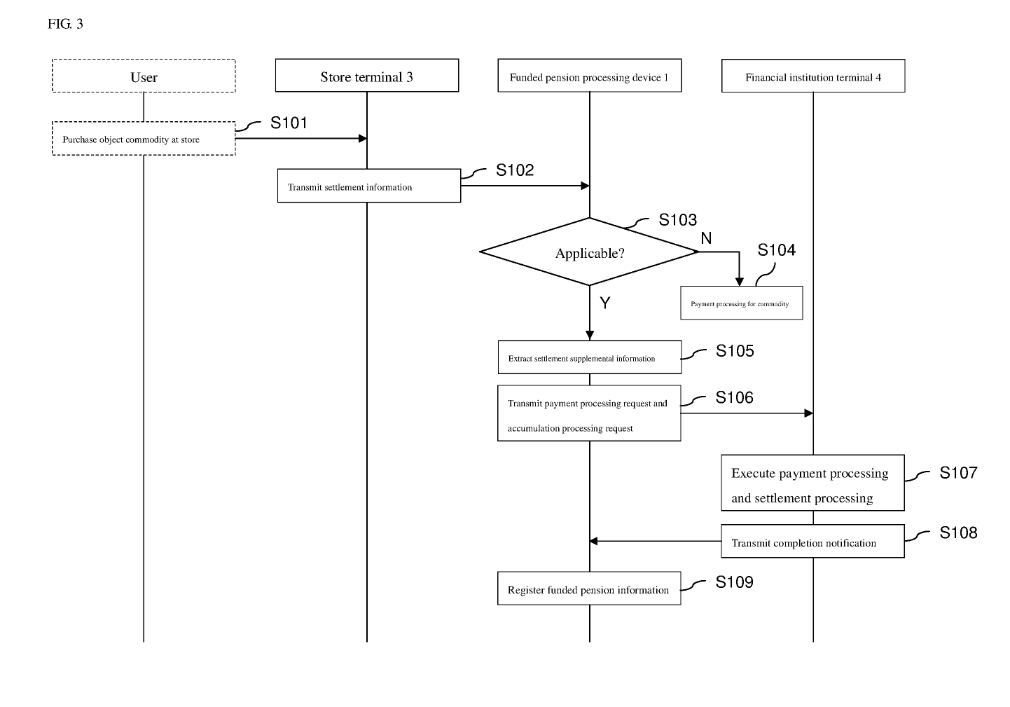

The flow of processing by the funded pension processing device 1 pertaining to the present embodiment will next be described with reference to FIG. 3.

In order for a user to enjoy the funded pension service, the user registers to use the service in advance or at the time of purchase of an object commodity of the funded pension service.

When a user purchases an object commodity of the funded pension service at a store (S101), settlement information is transmitted from the store terminal 3 to the funded pension processing device 1 (S102).

This settlement information includes a user ID for identifying the user, information pertaining to a settlement amount accompanying the commodity purchase by the user, and information pertaining to a funded pension sum that is set for the commodity purchased by the user.

The information pertaining to the funded pension sum that is set for the commodity is information indicating how much of the settlement amount of the commodity purchased by the user corresponds to the funded pension sum, but this information may also be configured as a specific amount, or may be configured as a percentage of the settlement amount.

The settlement information also includes the name of the store or user, information relating to the method used by the user to pay the charge for the commodity, and other information charge amount payment methods include credit card payment, direct debit, and the like, but credit card information for credit card payment, account information for direct debit, and other information necessary for charge amount settlement may be included in the settlement information, or this information may be registered in the user information DB 1A or the store information DB 1B in advance and extracted.

In the funded pension processing device 1 receiving the settlement information, the user information DB 1A is referred to by the determination processing unit 11, and the applicability of the funded pension service corresponding to the commodity purchase is determined for the user identified by the user ID (S103).

As a result, when it is determined that the funded pension service does not apply, only a request for payment processing of the settlement amount to the store for the commodity purchase by the user identified by the user ID is transmitted together with the settlement information to the financial institution terminal 4 (S104).

In response to the request for payment processing of the settlement amount to the store, when the settlement method is direct debit, processing is executed in the financial institution terminal 4 for transferring the commodity charge amount from a user account to a store account. In this case, when the information necessary for settlement is also registered in the user information DB 1A or the store information DB 1B, other information necessary for settlement is extracted, as appropriate, from the user information DB 1A or the store information DB 1B and transmitted to the financial institution terminal 4.

Meanwhile, when the result of the determination of applicability of the funded pension service in S103 is that the funded pension service applies, settlement supplemental information for supplementing the settlement information is first extracted, as appropriate, from the user information DB 1A or the store information DB 1B by the extraction processing unit 12 (S105).

The settlement supplemental information includes, for example, information pertaining to a receipt/payment account of the user or the store.

The request for payment processing of the settlement amount to the store and a request for accumulation processing of the funded pension that is set for the commodity purchased by the user are transmitted together with the settlement information or the settlement supplementary information to the financial institution terminal 4 (S106).

The financial institution terminal 4 receiving the payment processing request and the accumulation processing request executes payment processing of the commodity charge amount and accumulation processing of the pension (S107).

In these items of processing, the settlement supplemental information such as the account information of the store or the user is referred to, as appropriate, on the basis of the method of payment of the commodity charge amount, and transfer processing of the commodity charge amount or the funded pension is executed.

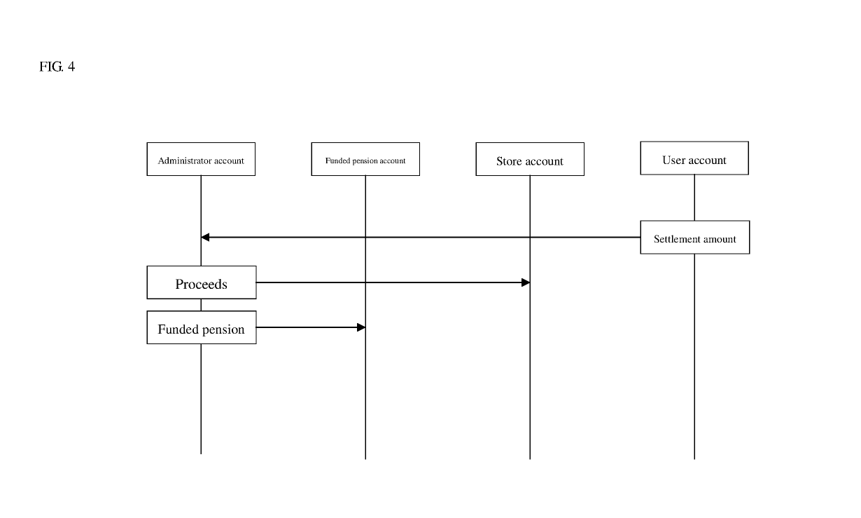

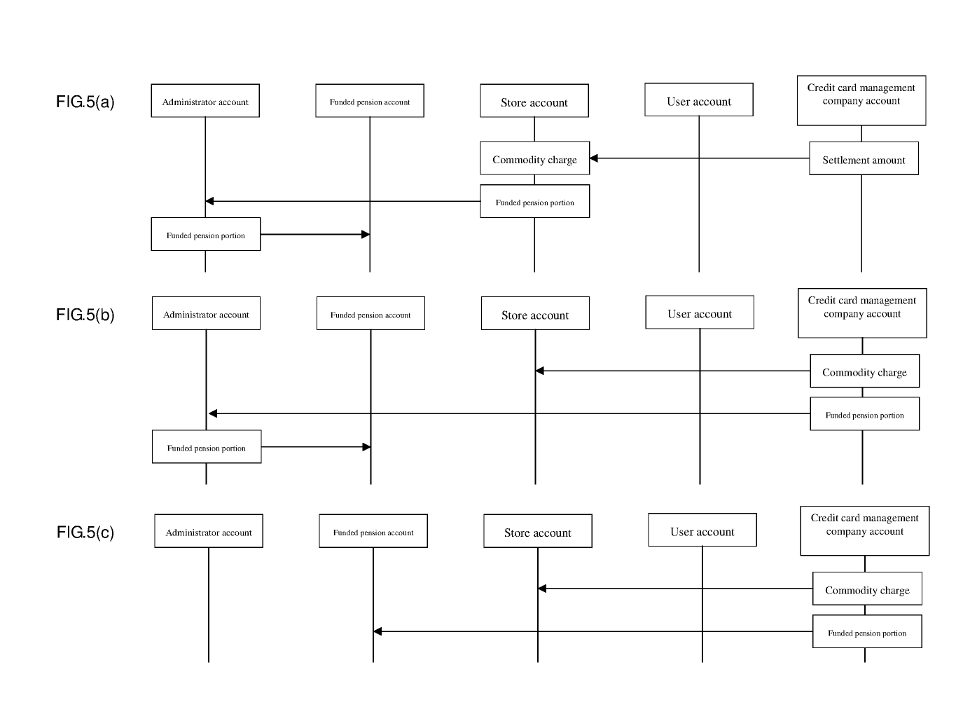

In each processing, the movement of commodity charge amounts or the funded pension between accounts takes various forms which also vary according to the price payment method, and specific examples thereof are illustrated in FIGS. 4 and 5.

FIG. 4 illustrates an example of a case in which the commodity charge amount is withdrawn from the user account. In the example of FIG. 4, the administrator account is an account managed by the administrator of the funded pension service.

In this example, the settlement amount is first transferred from the user account to the administrator account. The portion of the settlement amount that is the charge for the commodity is transferred as store proceeds from the administrator account to the store account. The funded pension portion of the settlement amount is also transferred as the funded pension of the user from the administrator account to the funded pension account of the user.

The charge for the commodity is thereby sorted into proceeds and funded pension.

FIG. 5 illustrates an example of a case in which the user uses a credit card.

In the example of FIG. 5(a), the settlement amount is first transferred from a credit card management company account to the store account. The portion of the settlement amount that is the charge for the commodity is left in the store account as store proceeds. The funded pension portion for the user is transferred from the store account to the funded pension account of the user via the administrator account. In the example of FIG. 5(b), the commodity charge amount is transferred from the credit card management company account to the store account, and the funded pension is transferred to the funded pension account of the user via the administrator account. In the example of FIG. 5(c), the commodity charge amount is transferred from the credit card management company account to the store account, and the funded pension is transferred directly to the funded pension account of the user.

The examples illustrated in FIGS. 4 and 5 are not limiting, and other examples of movement of the settlement amount, the proceeds, or the funded pension between accounts are possible, but in any of the movement forms, the proceeds accompanying a commodity purchase by the user are transferred to the store account, and the funded pension is transferred to the funded pension account whether directly from the credit card management company or via the store.

When payment processing and accumulation processing are completed, a completion notification is transmitted from the financial institution terminal 4 to the funded pension processing device 1 (S107).

In response to this notification, the funded pension registration unit 13 refers to the funded pension information DB 1C and registers the funded pension corresponding to the commodity purchase in correlation with the user who purchased the commodity (S108).

In the present example, payment of the price from the user to the store in the commodity purchase can also be performed by cash payment. In this case, for example, only a request for accumulation processing of the funded pension is transmitted together with the user or store information and the information pertaining to the funded pension sum from the funded pension processing device 1 to the financial institution terminal 4, and in response, the financial institution terminal 4 transfers the funded pension sum from the store account to the funded pension account. Also in this case, the funded pension sum may be temporarily transferred from the store account to the administrator account, and transferred from the administrator account to the funded pension account.

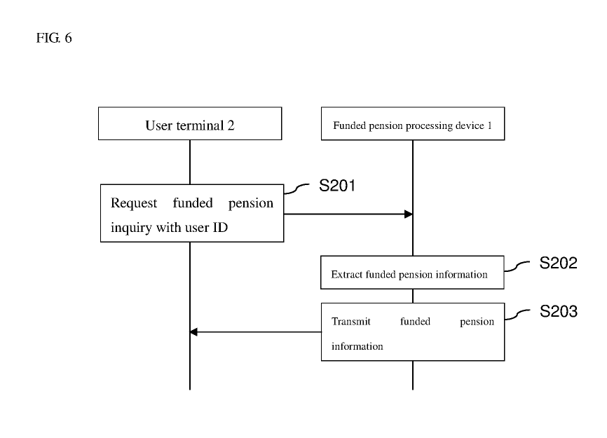

The flow of processing performed in response to a funded pension inquiry request from a user in the funded pension processing device 1 pertaining to the present embodiment is illustrated in FIG. 6.

When a funded pension inquiry request is transmitted together with a user ID from the user terminal 2 to the funded pension processing device 1 via a predetermined website or the like (S201), the funded pension processing device 1 refers to the funded pension information DB 1C and extracts the funded pension information of the user pertaining to the user ID through use of the extraction processing unit 12 (S202).

The extracted funded pension information is transmitted to the user terminal 2 (S203).

The funded pension continues to be accumulated in accordance with the purchase of an object commodity by the user, and the funded pension information DB 1C is also accordingly updated. The user can obtain his or her own funded pension information at any time.

Through use of the funded pension processing device 1 pertaining to the present embodiment described above, a pension is accumulated through a commodity purchase or other consumption, and it is thereby possible to accumulate a pension while avoiding consumption stagnation.

The pension is also accumulated in accordance with commodity purchases, and a funded pension is gradually saved for the user of the funded pension service, and it is therefore possible to comfortably transition a pension plan from a pay-as-you-go scheme to a funded scheme.

When the portion of the commodity charge amount that is allocated to the funded pension is handled by the store, the funded pension can be given to the user without imposing a burden on the user.

The offering of commodities having a high funded pension ratio or the like by a store also leads to increased opportunity for commodity sales, which results in reduced losses due to disposal of commodities, store or employee utilization rates increase, and labor productivity is enhanced.

### EXAMPLE 2

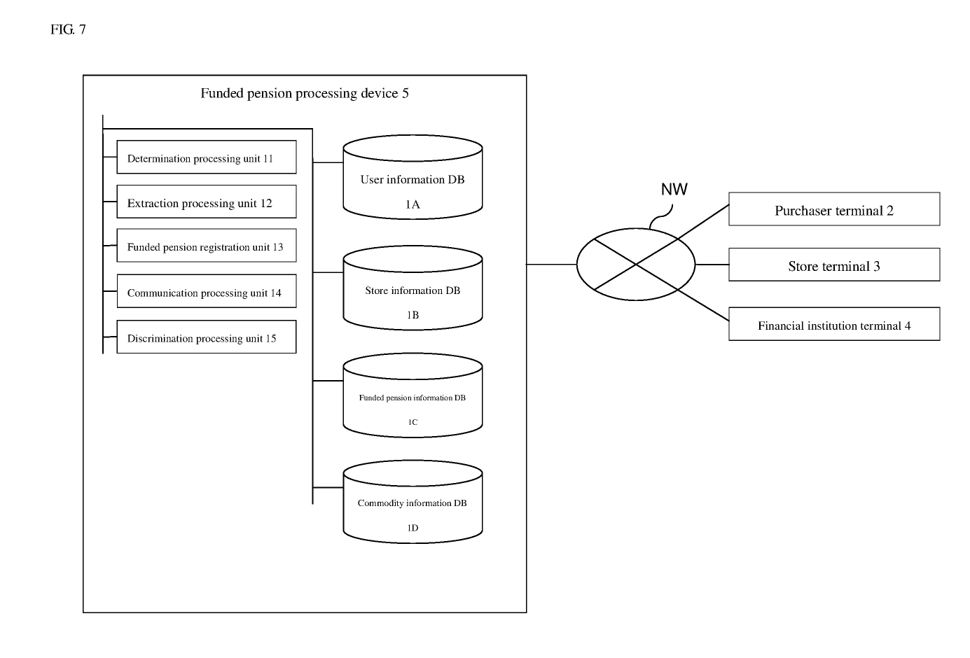

The funded pension processing device pertaining to a second embodiment of the present invention will next be described with reference to FIG. 7.

The funded pension processing device 5 pertaining to the present embodiment is configured so as to be able to communicate with a user terminal 2, a store terminal 3, and a financial institution terminal 4 via the Internet or another network NW, the same as the funded pension processing device 1 pertaining to the first embodiment, and is realized by the same hardware resources as the funded pension processing device 1.

The funded pension processing device 5 is provided with a commodity information DB 1D and a discrimination processing unit 15 as functional units in addition to the user information DB 1A, the store information DB 1B, the funded pension information DB 1C, the determination processing unit 11, the extraction processing unit 12, the funded pension registration unit 13, and the communication processing unit 14 provided to the funded pension processing device 1.

The commodity information DB 1D is a storage unit for storing information relating to an object commodity of the funded pension service.

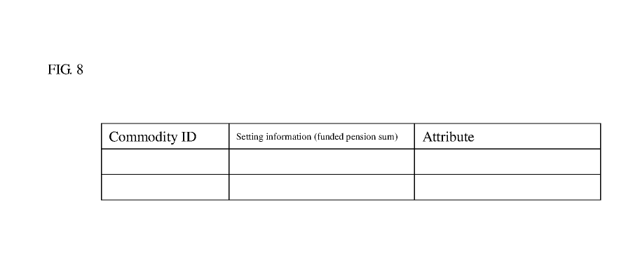

As illustrated in FIG. 8, for each commodity ID for identifying a commodity, a funded pension sum that is set for the commodity is stored as setting information in the commodity information DB 1D.

The funded pension sum for each commodity can be freely set by a store administrator or the like, and when a store transmits a request to register setting information together with the setting information to the funded pension processing device 5 through use of the store terminal 3, the funded pension processing device 5 registers the setting information. The setting information may be configured as a funded pension ratio that is set for a commodity charge amount.

Commodity attribute information is also registered for each commodity. The present example is configured so that user preference information and the like is registered in the user information DB 1A, and by extracting information of commodities of a genre that reflects the preference information of a user from the commodity information DB 1D and delivering the extracted commodity information to the user, the user can be encouraged to purchase a commodity.

The discrimination processing unit 15 executes processing for referring to the commodity information DB 1D on the basis of settlement information received from the store terminal 3 and discriminating whether a commodity purchased by a user is an object commodity of the funded pension service.

In the processing performed by the discrimination processing unit 15, the discrimination processing unit 15 receives information for discriminating a commodity as a portion of the settlement information by the store terminal 3, and refers to the commodity information DB 1D and discriminates whether the commodity is registered, on the basis of the information for identifying the commodity. When the commodity is not registered, the commodity is discriminated as not being an object commodity, and when the commodity is registered, the commodity is discriminated as being an object commodity.

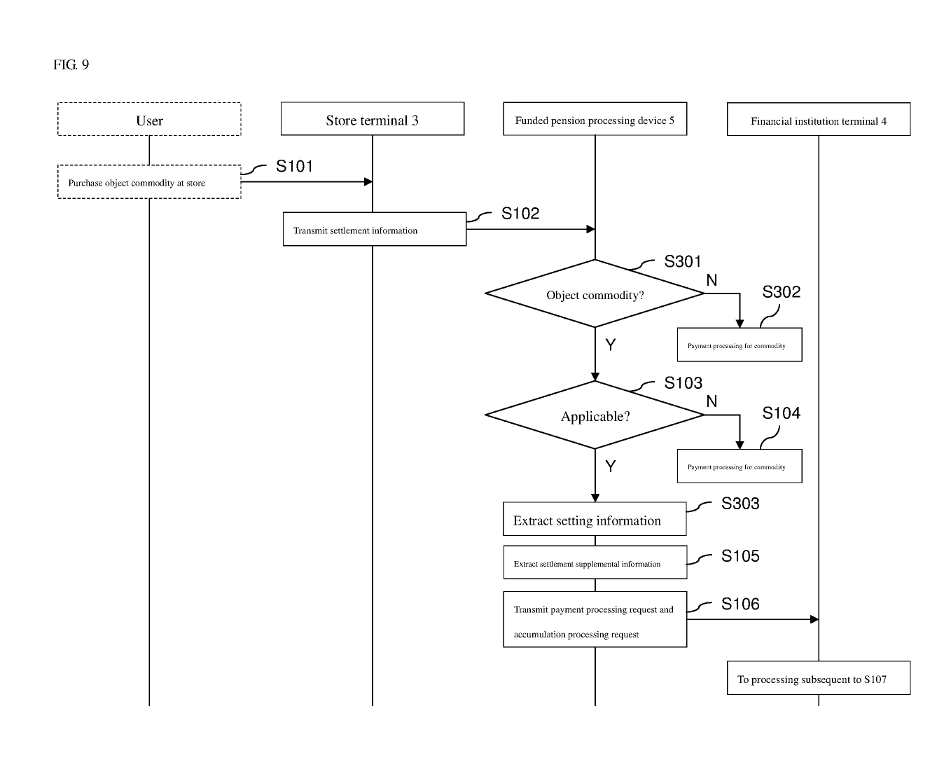

The processing performed by the funded pension processing device 5 pertaining to the present embodiment from a commodity purchase by a user to registration of the funded pension information will be described with reference to FIG. 9.

When a user purchases a commodity at a store (S101), settlement information is transmitted from the store terminal 3 to the funded pension processing device 5 (S102), the same as in the first embodiment.

The settlement information in the present example includes a user ID for identifying the user, information pertaining to a settlement amount accompanying the commodity purchase by the user, and a commodity ID whereby the commodity can be identified.

In the funded pension processing device 5 receiving the settlement information, the commodity information DB 1D is referred to by the discrimination processing unit 15, and processing is executed by the discrimination processing unit 15 for discriminating whether the commodity purchased by the user is an object commodity of the funded pension service (S301). This processing is executed by discriminating, on the basis of the commodity ID as a portion of the settlement information received from the store terminal 3, whether the commodity identified by the commodity ID is registered in the commodity information DB 1D.

As a result, when the commodity ID is not registered in the commodity information DB 1D and the commodity pertaining to the commodity ID is discriminated as not being an object commodity of the funded pension service, only a request for payment processing of the settlement amount to the store for the commodity purchase by the user identified by the user ID is transmitted together with the settlement information to the financial institution terminal 4 (S302). When a request for payment processing of the settlement amount is made to the financial institution terminal 4, information pertaining to a receipt/payment account of the user or the store, or other information may be extracted by the extraction processing unit 12 from the user information DB 1A or the store information DB 1B, as appropriate, as settlement supplemental information for supplementing the settlement information.

In response to the request for payment processing of the settlement amount to the store, processing is executed in the financial institution terminal 4 for transferring the commodity charge amount from a user account to a store account.

Meanwhile, when the commodity purchased by the user is discriminated as being an object commodity of the funded pension service in S301, the user information DB 1A is referred to by the determination processing unit 11 in the funded pension processing device 5, and the applicability of the funded pension service corresponding to the commodity purchase is determined for the user identified by the user ID (S103).

As a result, when it is determined that the funded pension service does not apply, only a request for payment processing of the settlement amount to the store for the commodity purchase by the user identified by the user ID is transmitted together with the settlement information to the financial institution terminal 4 (S104).

In response to the request for payment processing of the settlement amount to the store, the requested processing is executed in the financial institution terminal 4, such as for transferring the commodity charge amount from a user account to a store account.

Meanwhile, when the result of the determination of applicability of the funded pension service in S103 is that the funded pension service applies, the commodity information DB 1D is referred to, and the setting information of the commodity, i.e., the information pertaining to the funded pension sum that is set for the commodity, is extracted by the extraction processing unit 12 (S303).

Settlement supplemental information for supplementing the settlement information is then extracted, as appropriate, by the extraction processing unit 12 from the user information DB 1A or the store information DB 1B (S105).

The settlement supplemental information includes, for example, information pertaining to a receipt/payment account of the user or the store.

The request for payment processing of the settlement amount to the store and a request for accumulation processing of the funded pension that is set for the commodity purchased by the user are transmitted together with the settlement information or the settlement supplementary information to the financial institution terminal 4 (S106).

The processing subsequent to S107 is then executed in the same manner as in the first embodiment, and the funded pension corresponding to the commodity purchase is registered for the user.

In the funded pension processing device 5 pertaining to the present embodiment, the user information DB 1A and the commodity information DB 1D are referred to, and commodity information corresponding to the preference of the user is delivered to the user terminal 2 of the user at a predetermined timing.

By delivering such commodity information that corresponds to the preference of the user, the user can be encouraged to purchase a commodity, and the user can obtain a large amount of funded pension savings.

Also through use of the funded pension processing device pertaining to the present embodiment described above, a pension is accumulated through a commodity purchase or other consumption, and it is thereby possible to accumulate a pension while avoiding consumption stagnation.

The ability to set a funded pension sum for each commodity and to deliver commodity information that corresponds to the preference of the user also leads to accelerated commodity sales.

Regarding the means and method for determining the sum to give as a funded pension for each commodity or service, an allocation ratio for a sum of money or a price given to the commodity or service is displayed. The method of display is the same as is commonly used for a discount price or discount rate.

In this case, the funded pension sum given is displayed and declared to the user in the same manner as a base price, discount rate, discount price, and consumption tax are displayed using a function of a register system. The pension sum given by a store and the sum paid to a pension operating company are managed, and in addition to these items of information, the date, a personal number for specifying an individual, a store number for specifying the store, a commodity number, a commodity name, and other sales information is retained. The funded pension sum can be collected from the store and accumulated on the basis of the above sales information.

Regarding the means and method whereby a pension manager collects the sum to be given as the funded pension of an individual and accumulates the sum for the user, there is concern in cases where cash is used, or that a store may give change or chips to a shopper as the pension portion. As a means for avoiding this problem, a store contracts with the pension management company in advance as a store that can implement pension giving, and the store is given a unique store number. The user receiving the pension also contracts with the pension management company and is given an individually unique personal number. When settling at the store register, the user preferably presents the personal number.

As authentication means on the user side, a face, fingerprint, or other bio-information, a card on which a barcode or QR Code (registered trademark) is printed, a magnetic card, an NFC card, or a function in a portable telephone or smartphone, tablet terminal, wearable terminal, or the like may be used. As authentication means on the store side, a face, fingerprint, or other bio-information, a card on which a barcode or QR Code (registered trademark) is printed, a magnetic card, an NFC card, or a function in a portable telephone or smartphone, tablet terminal, wearable terminal, or the like may be used. The authentication means may or may not cooperate with the register system.

During payment, the store always identifies the settlement means, whether credit card, debit card, pre-paid card, electronic money, virtual currency, Bitcoin, or the earnings-secured settlement described hereinafter. Since user authentication is also necessary, the user is requested to present his or her personal number, and the user is also authenticated by a store-side authentication means. Preferably, the store number of the store, the personal number of the user, the date, the commodity number or price of the commodity purchased, and the money sum given to the user as the pension are printed on a receipt delivered to the user. The use of a receipt is not limiting, and another printed matter or electronic data may also be used, and in the case of electronic data, a configuration may be adopted whereby the electronic data are stored in a server connected to a network, and the data can be viewed or outputted upon request by the user.

As the method for identifying the settlement means, whether credit card, debit card, pre-paid card, electronic money, virtual currency, Bitcoin, or the earnings-secured settlement described hereinafter, the settlement means may be selected by a register function, a specifying means incorporated in advance for identification may be used, or an identification function of a terminal may be utilized for identification.

The funded pension given to the user is collected from the store by the pension management company or a clearing company. The funded pension given from the store can be collected by credit card, debit card, pre-paid card, electronic money, virtual currency, Bitcoin, or the like, and the earnings-secured settlement described hereinafter or the method for collecting the pension sum to be given from the pension management company may be the same as for cash.

In the case that each settlement company temporarily receives the money sum given as the pension by credit card, debit card, pre-paid card, electronic money, virtual currency, Bitcoin, or the earnings-secured settlement described hereinafter, the pension operating company or a clearing company collects from each settlement company. The method of pension collection from the settlement company may be any of cash, bank transfer, bank account direct debit, actual goods, virtual currency, or the like, and any method that has value and is exchangeable for cash may be used.

Regarding the means and method for determining the sum to give as a funded pension for each commodity or service, an allocation ratio for a sum of money or a price given to the commodity or service is displayed. The method of display is the same as is commonly used for a discount price or discount rate.

In this case as well, the funded pension sum given is displayed and declared to the user in the same manner as a base price, discount rate, discount price, and consumption tax are displayed using a function of a register system. The pension sum given by a store and the sum paid to the pension operating company are also managed, and in addition to these items of information, the date, a personal number for specifying an individual, a store number for specifying the store, a commodity number, a commodity name, and other sales information is retained. The funded pension sum can be collected from the store and accumulated on the basis of the above sales information.

### EXAMPLE 3

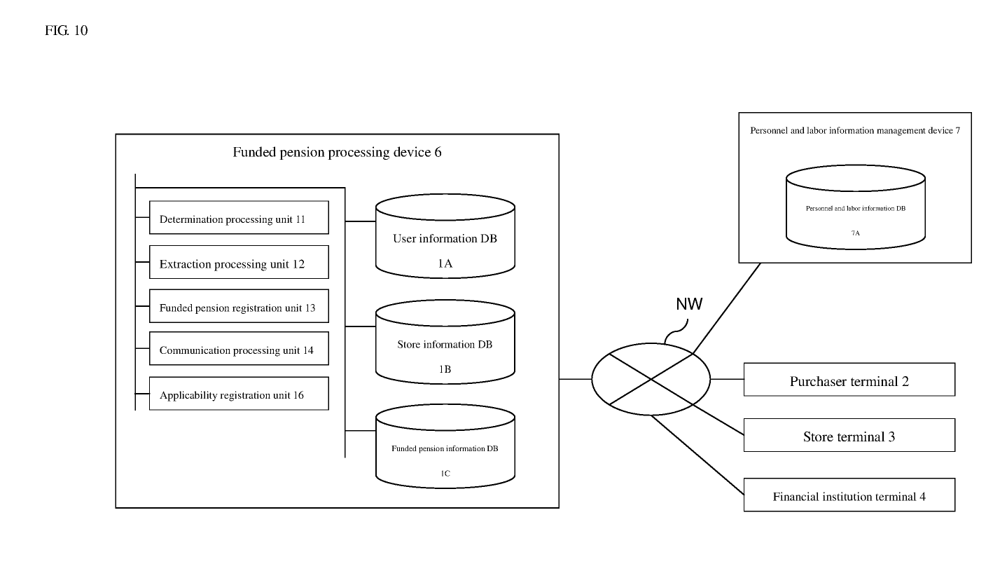

The funded pension processing device pertaining to a third embodiment of the present invention will next be described with reference to FIG. 10.

The funded pension processing device 6 pertaining to the present embodiment is configured so as to be able to communicate with a personnel and labor information management device 7 in addition to a user terminal 2, a store terminal 3, and a financial institution terminal 4 via the Internet or another network NW, the same as the funded pension processing device 1 pertaining to the first embodiment, and is realized by the same hardware resources as the funded pension processing device 1.

The funded pension processing device 6 is provided with an applicability registration unit 16 as a functional unit in addition to the user information DB 1A, the funded pension information DB 1C, the determination processing unit 11, the extraction processing unit 12, the funded pension registration unit 13, and the communication processing unit 14 provided to the funded pension processing device 1.

The applicability registration unit 16 refers to personnel and labor information stored in a personnel and labor information DB 7A of the personnel and labor information management device 7, and executes processing for registering, in the user information DB 1A, the applicability of a funded pension service assigned in accordance with the personnel and labor information.

When a user having a certain yearly income or less is the target for the funded pension service, for example, the above processing is executed by referring to the yearly income information of the user included in the personnel and labor information, discriminating a user who satisfies the yearly income condition, and registering the discriminated information pertaining to applicability in the user information DB 1A.

The personnel and labor information management device 7 is a device for managing personnel and labor information relating to personnel affairs and labor of the user as a worker. The personnel and labor information management device is realized by a server computer or the like, and is provided with the personnel and labor information DB 7A.

The personnel and labor information DB 7A is a storage unit for storing the personnel and labor information of the user as a worker, and personnel and labor information such as personnel affairs, attendance, and earnings are correlated for each user and stored therein.

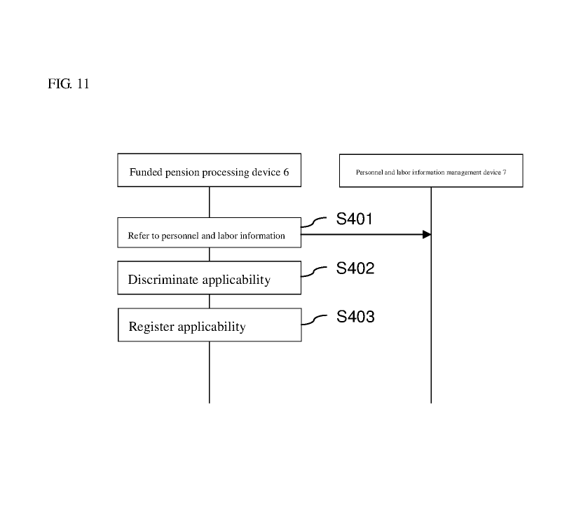

The flow of processing performed when applicability of a funded pension service is registered in the funded pension processing device 6 pertaining to the present embodiment will next be described with reference to FIG. 11.

In the funded pension processing device 6, at a predetermined timing such as when a user registers to use the funded pension service or when the personnel and labor information is updated, the personnel and labor information in the personnel and labor information DB 7A is referred to (S401) and the applicability of the funded pension service is discriminated for each user by the applicability registration unit 16 (S402).

The applicability of the funded pension service is discriminated in accordance with yearly income or another predetermined condition by whether the user satisfies the condition.

When the applicability is discriminated, the discrimination details are registered in the user information DB 1A (S403).

In the funded pension processing device 6 pertaining to the present embodiment, the processing executed from a commodity purchase by a user to registration of the funded pension information is substantially the same as the processing previously described with reference to FIG. 3 that is performed by the funded pension processing device 1 pertaining to the first embodiment.

In the present example, however, the extraction processing unit 12 may extract information from the personnel and labor information DB 7A in addition to the user information DB 1A or the store information DB 1B as settlement supplemental information in S105 of FIG. 3.

In the present example in which the funded pension processing device 6 is configured so as to be able to communicate the personnel and labor information management device 7, with regard to payment of the charge amount accompanying a commodity purchase by the user, a business or other employer that employs the user as a worker can temporarily advance the purchase charge for the commodity with an earnings credit of the user as an upper limit.

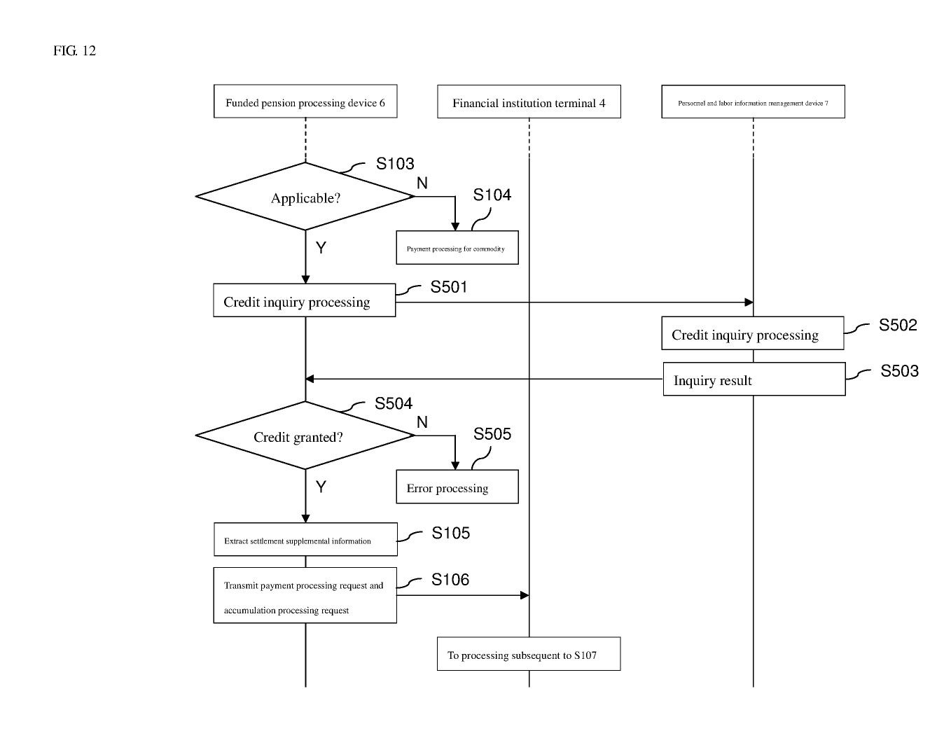

FIG. 12 illustrates an example of the flow of processing for such a case in which accumulation processing of the funded pension and payment processing of the commodity charge amount by an employer advance of the purchase charge amount of a commodity are executed.

When a user requests settlement by advancement of the purchase charge amount of a commodity by an employer, a processing request for the settlement by advancement is transmitted along with the settlement information when the settlement information is transmitted from the store terminal 3 to the funded pension processing device 6.

In response, when the result of the determination of applicability of the funded pension service in S103 is that the funded pension service applies, the funded pension processing device 6 transmits a credit inquiry together with information whereby the user can be identified and information pertaining to the settlement amount needed for the commodity purchase to the personnel and labor information management device 7 (S501).

In response, the personnel and labor information management device 7 executes credit inquiry processing (S502). In this processing, earnings information of the user is first referred to, and an earnings sum to be supplied to the user is specified. Using the earnings sum to be supplied as a credit limit, a determination is then made as to whether the settlement amount needed for the commodity purchase is within the credit limit.

The result of the credit inquiry is transmitted to the funded pension processing device 6 (S503), and when credit is granted, settlement supplemental information for supplementing the settlement information is extracted, as appropriate, by the extraction processing unit 12 from the user information DB 1A or the store information DB 1B (S105).

In the extraction of settlement supplemental information in the present example, information relating to an account of a business or other employer at which the user works as a worker and other information are extracted as settlement supplemental information from the personnel and labor information DB 7A as well.

When the result of the credit inquiry is that credit is not granted, notification is returned to the store terminal 3 as by an error message or the like indicating that settlement by advancement of the purchase charge amount of the commodity by the employer cannot be performed, and processing is ended (S505).

The request for payment processing of the settlement amount to the store and a request for accumulation processing of the funded pension that is set for the commodity purchased by the user are transmitted together with the settlement information or the settlement supplementary information to the financial institution terminal 4 (S106).

The processing subsequent to S107 is then executed in the same manner as in the first embodiment, and the funded pension corresponding to the commodity purchase is registered for the user.

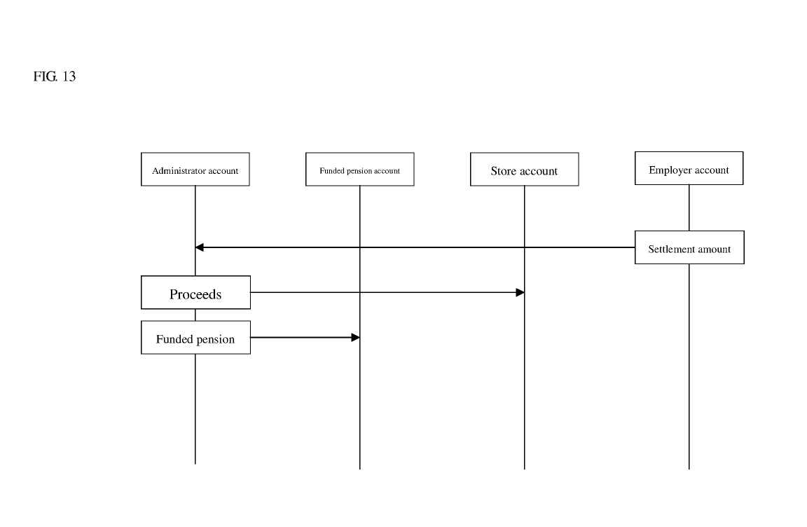

Movement of the commodity charge amount or the funded pension between accounts in the processing performed in the financial institution to transfer the commodity charge amount or the funded pension is performed according to the example illustrated in FIG. 13.

In this example, the settlement amount is first transferred from the employer account to the administrator account. The portion of the settlement amount that is the charge for the commodity is transferred as store proceeds from the administrator account to the store account. The funded pension portion of the settlement amount is also transferred as the funded pension of the user from the administrator account to the funded pension account of the user.

The charge for the commodity is thereby sorted into proceeds and funded pension.

Also through use of the funded pension processing device pertaining to the present embodiment described above, a pension is accumulated through a commodity purchase or other consumption, and it is thereby possible to accumulate a pension while avoiding consumption stagnation.

Because the applicability of the funded pension service can also be set on the basis of the personnel and labor information of the user as a worker, it is possible to rectify poverty and income disparity such as by limiting application of the service to users having a low yearly income.

Furthermore, since it is possible to temporarily advance the charge for a commodity with an earnings credit as an upper limit on the basis of the personnel and labor information, a commodity can be purchased even by a worker who has no money at the time of the commodity purchase.

In the present embodiment, a configuration is preferably adopted whereby a system that cooperates with the personnel and labor information management device 7 is provided to the user, and the accumulation status of the funded pension, as well as a bestowal rate of the funded pension or information of commodities or the like having a high bestowal rate are individually provided to the user via a predetermined personalized web page. The information provided is preferably transmitted on the basis of various types of information including information such as the workplace location or location where the user lives, the user's age, sex, nationality, a qualification, or other personal information, the yearly income, official position, type of employment, or other employment contract information of the user, information such as holidays, work leaving time, a business trip location, and a business trip time, and information such as industry type and work details.

Such information is effectively provided by displaying the information on a login screen that is frequently accessed by the user. Specifically, by providing the user with numerous opportunities to see information relating to the funded pension, the user can be guided to a commodity for which the funded pension is set, and advertising or sales-promoting effects can be obtained. As a result, stores will also proactively seek to bestow a funded pension for a commodity, and a virtuous circle is created.

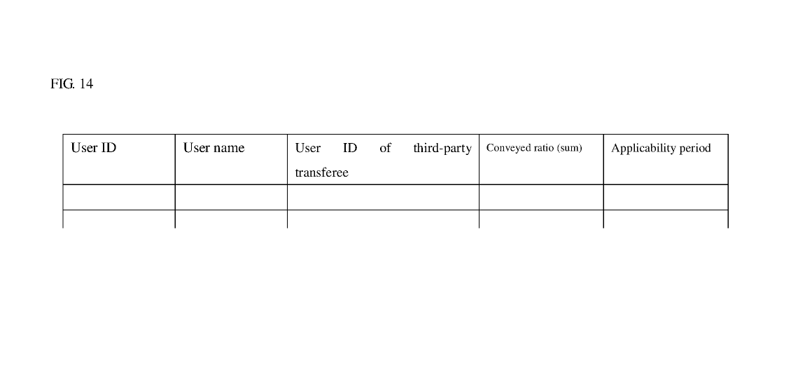

The embodiments of the present invention described above may be configured so that a funded pension accumulated by a user can be conveyed to a third party. In this case, a conveyance information DB for registering information relating to conveyance of the funded pension, for example, is provided. The user registers conveyance information such as the third party as the assignee of the funded pension or a sum or rate to be conveyed to the third party by the user in the conveyance information DB in advance. FIG. 14 illustrates an example of the data of the conveyance information DB in a case in which such conveyance information relating to the third party as the transferee of the funded pension and the details of the conveyance are registered.

The third party to which such conveyance of the funded pension is made may be the family of the user, a specific relative of the user, or another specific person or an unspecified person, and is not particularly limited, but it is preferred that the user be able to freely set the third party by an operation performed personally by the user. The meaning of conveyance in this case also includes the concept of donation or gift giving, and broadly denotes the act of handing over the funded pension to a third party.

When such conveyance information is registered, when a request for accumulation processing of the funded pension is transmitted to the financial institution, the conveyance information is extracted as settlement supplemental information and transmitted together with a request for accumulation processing of the funded pension to the financial institution. A portion of the funded pension of the user is then registered as a funded pension in the name of a designated third party.

Regarding conveyance of accumulated funds to the third party, it is preferably possible to set a period for conveying a portion of the funded pension to the third party. Specifically, the user or the like determines a fixed applicable period as a portion of the registered information. Through this configuration, it is possible only for the fixed applicable period for the user to convey a portion of the funded pension obtained from a commodity purchase to a predetermined third party during accumulation processing of the funded pension.

As a result of the ability to convey the funded pension to a third party, a pension can be given not only to the user personally, but also to a person as an expression of gratitude from the user, a person from whom the user learned a trade, or another person. As a result, guidance or education of younger generations can also be anticipated, and technological innovation and work innovation are made possible through passing on of skills.

The funded pension accumulated for each user can also be retained in the form of currency, virtual currency, a financial product, or the like in the business or organization that manages the funded pension. The funded pension can also be paid to the user in the form of cash, a bank transfer, a pre-paid card, electronic money, virtual currency, Bitcoin, and various other forms.

The funded pension accumulated for each user may also be configured so as to be operated with or without the consent of the user by the business or organization that manages the funded pension. The funded pension also be operated as a principal-guaranteed financial product or a non-principal-guaranteed financial product, in accordance with the personal entrustment and choice of the user. When the funded pension is operated in this manner, it is preferably possible for the user to view the operation status thereof in real time through an Internet service at any time and from any place.

### REFERENCE SIGNS LIST

1 funded pension processing device
1A user information DB
1B store information DB
1C funded pension information DB
11 determination processing unit
12 extraction processing unit
13 funded pension registration unit
14 communication processing unit
2 user terminal
3 store terminal
4 financial institution terminal
5 funded pension processing device
1D commodity information DB
15 discrimination processing unit
6 funded pension processing device
16 applicability registration unit
7 personnel and labor information management device
7A personnel and labor information DB
NW network

1. A funded pension processing device for providing, in response to a commodity purchase by a user, a funded pension service for accumulating a portion of the charge for the commodity as a funded pension for the user,
said funded pension processing device being configured to be capable of communicating via a network with
a store terminal installed in a store selling the commodity, and
a financial institution terminal for executing processing pertaining to charge amount settlement and pension accumulation accompanying the commodity purchase by the user; and
said funded pension processing device comprising:
funded pension information storage means for storing funded pension information pertaining to the funded pension accumulated in accordance with purchasing of the commodity by the user;
settlement information reception means for receiving, from the store terminal, user identification information for identifying the user, information pertaining to a settlement amount accompanying the commodity purchase by the user, and information pertaining to a funded pension sum that is set for the commodity purchased by the user as settlement information of the commodity purchase by the user;
processing request transmission means for transmitting, together with the settlement information to the financial institution terminal, a request for payment processing of the settlement amount to the store and a request for accumulation processing of the funded pension that is set for the commodity purchased by the user, for the commodity purchase by the user identified by the user identification information;
completion notification reception means for receiving notification from the financial institution terminal that accumulation processing of the funded pension is completed; and
funded pension registration means for registering information pertaining to the funded pension for which the accumulation processing is completed in the funded pension information storage means.

2. The funded pension processing device of claim 1, further comprising:
user information storage means for storing applicability of the funded pension service for each user; and
determination processing means for referring to the user information storage means and determining applicability of the funded pension service corresponding to the commodity purchase for the user identified by the user identification information;
the processing request transmission means transmitting, together with the settlement information to the financial institution terminal, a request for payment processing of the settlement amount to the store and a request for accumulation processing of the funded pension that is set for the commodity purchased by the user, for the commodity purchase by the user identified by the user identification information when it is determined that the funded pension service corresponding to the commodity purchase can apply for the user identified by the user identification information.

3. The funded pension processing device of claim 2, further configured to be able to communicate via a network with a personnel and labor information management device having a personnel and labor information storage means in which personnel and labor information of the user as a worker is stored; and
further comprising applicability registration means for referring to the personnel and labor information storage means and registering, in the user information storage means, the applicability of the funded pension service assigned in accordance with the personnel and labor information.

4. The funded pension processing device of claim 1, further configured to be able to communicate via a network with a user terminal used by the user; and
further comprising
object commodity information reception means for receiving object commodity information pertaining to an object commodity of the funded pension service from the store terminal; and
object commodity information delivery means for delivering the object commodity information to the user terminal.

5. The funded pension processing device of claim 1, further configured to be able to communicate via a network with the user terminal used by the user; and
further comprising
inquiry request reception means for receiving an inquiry request for the funded pension information together with the user identification information from the user terminal;
extraction processing means for referring to the funded pension information storage means and extracting the funded pension information on the basis of the user identification information; and
funded pension information delivery means for delivering the funded pension information to the user terminal.

6. The funded pension processing device of claim 1, further comprising conveyance information storage means for storing conveyance information relating to details of conveyance to a third party other than the user, for a portion of the funded pension accumulated in accordance with a commodity purchase by the user;
the processing request transmission means furthermore transmitting the conveyance information stored in the conveyance information storage means.

7. The funded pension processing device of claim 6, further configured to be able to communicate via a network with the user terminal used by the user; and
further comprising
conveyance information reception means for receiving the conveyance information from the user terminal; and
conveyance information registration means for referring to the conveyance information storage means and registering the conveyance information.

8. A funded pension processing device for providing, in response to a commodity purchase by a user, a funded pension service for accumulating a portion of the price of the commodity as a funded pension for the user,
said funded pension processing device being configured to be capable of communicating via a network with
a store terminal installed in a store selling the commodity, and
a financial institution terminal for executing processing pertaining to charge amount settlement and pension accumulation accompanying the commodity purchase by the user; and
said funded pension processing device comprising:
commodity information storage means for storing setting information pertaining to a funded pension sum that is set for each commodity;
funded pension information storage means for storing funded pension information pertaining to the funded pension accumulated in accordance with purchasing of the commodity by the user;
settlement information reception means for receiving, from the store terminal, user identification information for identifying the user and information pertaining to a settlement amount accompanying the commodity purchase by the user as settlement information of the commodity purchase by the user;
extraction processing means for referring to the commodity information storage means and extracting the setting information pertaining to the funded pension sum that is set for the commodity purchased by the user;
processing request transmission means for transmitting, together with the settlement information and the setting information to the financial institution terminal, a request for payment processing of the settlement amount to the store and a request for accumulation processing of the funded pension that is set for the commodity purchased by the user, for the commodity purchase by the user identified by the user
completion notification reception means for receiving notification from the financial institution terminal that accumulation processing of the funded pension is completed; and
funded pension registration means for registering information pertaining to the funded pension for which the accumulation processing is completed in the funded pension information storage means.

9. The funded pension processing device of claim 6, further comprising discrimination processing means for referring to the commodity information storage means on the basis of settlement information received from the store terminal and discriminating whether a commodity purchased by the user is an object commodity of the funded pension service;
the commodity information storage means storing setting information pertaining to a funded pension sum that is set for each object item, for the object commodity of the funded pension service; and
the extraction processing means referring to the commodity information storage means when the commodity purchased by the user is discriminated as being an object commodity of the funded pension service, and extracting the setting information pertaining to the funded pension sum that is set for the object commodity purchased by the user.

10. The funded pension processing device of claim 8, further comprising setting information reception means for receiving, from the store terminal, setting information pertaining to the funded pension sum that is set for the commodity; and
setting information registration means for referring to the commodity information storage means and registering the setting information.

11. A method for providing, in response to a commodity purchase by a user, a funded pension service for accumulating a portion of the charge for the commodity as a funded pension for the user, said method comprising
executing processing through use of a computer that is configured to be capable of communicating via a network with
a store terminal installed in a store selling the commodity, and
a financial institution terminal for executing processing pertaining to charge amount settlement and pension accumulation accompanying the commodity purchase by the user,
the computer comprising funded pension information storage means for storing funded pension information pertaining to the funded pension accumulated in accordance with purchasing of the commodity by the user; and
processing for receiving, from the store terminal, user identification information for identifying the user, information pertaining to a settlement amount accompanying the commodity purchase by the user, and information pertaining to a funded pension sum that is set for the commodity purchased by the user as settlement information of the commodity purchase by the user;
processing for transmitting, together with the settlement information to the financial institution terminal, a request for payment processing of the settlement amount to the store and a request for accumulation processing of the funded pension that is set for the commodity purchased by the user, for the commodity purchase by the user identified by the user identification information;
processing for receiving notification from the financial institution terminal that accumulation processing of the funded pension is completed; and
processing for registering information pertaining to the funded pension for which the accumulation processing is completed in the funded pension information storage means.

12. A computer program for providing, in response to a commodity purchase by a user, a funded pension service for accumulating a portion of the charge for the commodity as a funded pension for the user,
said computer program causing a computer to execute processing, and the computer being configured to be capable of communicating via a network with
a store terminal installed in a store selling the commodity, and
a financial institution terminal for executing processing pertaining to charge amount settlement and pension accumulation accompanying the commodity purchase by the user,
the computer comprising funded pension information storage means for storing funded pension information pertaining to the funded pension accumulated in accordance with purchasing of the commodity by the user; and
the processing caused by the computer program comprising:
processing for receiving, from the store terminal, user identification information for identifying the user, information pertaining to a settlement amount accompanying the commodity purchase by the user, and information pertaining to a funded pension sum that is set for the commodity purchased by the user as settlement information of the commodity purchase by the user;
processing for transmitting, together with the settlement information to the financial institution terminal, a request for payment processing of the settlement amount to the store and a request for accumulation processing of the funded pension that is set for the commodity purchased by the user, for the commodity purchase by the user identified by the user identification information;
processing for receiving notification from the financial institution terminal that accumulation processing of the funded pension is completed; and
processing for registering information pertaining to the funded pension for which the accumulation processing is completed in the funded pension information storage means.

13. A method for providing, in response to a commodity purchase by a user, a funded pension service for accumulating a portion of the price of the commodity as a funded pension for the user, said funded pension processing method comprising
executing processing through use of a computer that is configured to be capable of communicating via a network with
a store terminal installed in a store selling the commodity, and
a financial institution terminal for executing processing pertaining to charge amount settlement and pension accumulation accompanying the commodity purchase by the user,
the computer comprising i) commodity information storage means for storing setting information pertaining to a funded pension sum that is set for each commodity and ii) funded pension information storage means for storing funded pension information pertaining to the funded pension accumulated in accordance with purchasing of the commodity by the user; and
processing for receiving, from the store terminal, user identification information for identifying the user and information pertaining to a settlement amount accompanying the commodity purchase by the user as settlement information of the commodity purchase by the user;
processing for referring to the commodity information storage means and extracting the setting information pertaining to the funded pension sum that is set for the commodity purchased by the user;
processing for transmitting, together with the settlement information and the setting information to the financial institution terminal, a request for payment processing of the settlement amount to the store and a request for accumulation processing of the funded pension that is set for the commodity purchased by the user, for the commodity purchase by the user identified by the user identification information;
processing for receiving notification from the financial institution terminal that accumulation processing of the funded pension is completed; and
processing for registering information pertaining to the funded pension for which the accumulation processing is completed in the funded pension information storage means.

14. A funded pension processing method for providing, in response to a commodity purchase by a user, a funded pension service for accumulating a portion of the price of the commodity as a funded pension for the user,
said funded pension processing method causing a computer to execute processing, and the computer being configured to be capable of communicating via a network with
a store terminal installed in a store selling the commodity; and
a financial institution terminal for executing processing pertaining to charge amount settlement and pension accumulation accompanying the commodity purchase by the user,
the computer comprising i) commodity information storage means for storing setting information pertaining to a funded pension sum that is set for each commodity, and ii) funded pension information storage means for storing funded pension information pertaining to the funded pension accumulated in accordance with purchasing of the commodity by the user; and
the processing caused by the funded pension processing method comprising:
processing for receiving, from the store terminal, user identification information for identifying the user and information pertaining to a settlement amount accompanying the commodity purchase by the user as settlement information of the commodity purchase by the user;
processing for referring to the commodity information storage means and extracting the setting information pertaining to the funded pension sum that is set for the commodity purchased by the user;
processing for transmitting, together with the settlement information and the setting information to the financial institution terminal, a request for payment processing of the settlement amount to the store and a request for accumulation processing of the funded pension that is set for the commodity purchased by the user, for the commodity purchase by the user identified by the user identification information;
processing for receiving notification from the financial institution terminal that accumulation processing of the funded pension is completed; and
processing for registering information pertaining to the funded pension for which the accumulation processing is completed in the funded pension information storage means.
